(19) United States
(12) Patent Application Publication
(10) Pub. No.: US 2016/0356725 A1
(43) Pub. Date: Dec. 8, 2016

(54) APPARATUS AND METHOD FOR INSPECTION OF A MID-LENGTH SUPPORTED STEERING COLUMN ASSEMBLY

(71) Applicant: NSK AMERICAS, INC., Ann Arbor, MI (US)

(72) Inventors: George Morrison, III, Taylor, MI (US); Ty Alan Brown, Clarinda, IA (US); Timothy Brian Rood, Ann Arbor, MI (US)

(21) Appl. No.: 15/116,554

(22) PCT Filed: Feb. 4, 2015
(86) PCT No.: PCT/US2015/014427

§ 371 Date: Aug. 4, 2016

Related U.S. Application Data
(60) Provisional application No. 61/935,419, filed on Feb. 4, 2014.

(51) Int. Cl. G01N 21/88; G01B 11/00

(52) U.S. Cl. CPC G01N 21/8851; G01B 11/00; G01N 2021/888; G01N 2201/103; B62D 1/185

(57) ABSTRACT

An apparatus (110) (and associated method) for inspecting a steering column assembly (10) including at least one motorized roller support assembly (118) that is adapted to rotatably support the steering column assembly at least partially along its length, and at least one optical scanning device (158) adapted to optically scan a feature of Interest of the steering column assembly while the shaft of the steering column assembly is rotated for gathering data for identifying one or more deviations from one or more predetermined values for the feature of interest.

### CLAIM OF BENEFIT OF FILING DATE AND PRIORITY

The present application claims the benefit of the filing date of, and priority to, U.S. application Ser. No. 61/935,419, filed Feb. 4, 2014, which is hereby incorporated by reference in its entirety. The present application is also related to U.S. application Ser. No. 61/935421, filed Feb. 4, 2014, which is hereby incorporated by reference in its entirety.

### FIELD

In general, the present teachings relate to an apparatus and method for inspection of a steering column assembly before installation into a transportation vehicle. More particularly, the present teachings relate to an apparatus and method for non-contact inspection of a steering column assembly for an automotive vehicle while the steering column assembly is rotatably supported at least partially along its length.

### BACKGROUND

In the manufacture of steering column assemblies, there are often a number of subassemblies or components that require assembly with each other. For proper operation, many of the subassemblies or components are adapted for rotation about a longitudinal axis upon installation into a vehicle for which it is intended, it is important in the manufacture of steering column assemblies that individual subassemblies or components are properly attached to one another. This is often achieved by one or more crimping, staking or other plastic deformation operations by which a sleeve, a tube, a disk or some other generally cylindrical and hollow object is connected around a shaft, or some other generally cylindrical component so that the connected parts resist longitudinal separation, resist radial displacement, or both. Though it is possible for an assembly line worker to perform a visual and/or manual inspection for quality assurance, such an inspection leaves open the possibility of some subjectivity from one worker to another, and may lead to potentially inconsistent results.

There is a need for an automated approach to the inspection of steering column assemblies (“steering column assemblies” as used herein contemplate not only final steering column assemblies adapted for installation into a vehicle, but also subassemblies that are incorporated into final steering column assemblies) before installation of the same into a vehicle. There is a particular need for a non-contact approach to the inspection of steering column assemblies (e.g., joints between components of the assemblies) by which the device that conducts the inspection does so without making contact with steering column assemblies while being inspected. There is also a need for an approach to steering column assemblies that allows for rotation of steering column assemblies, but which avoids contact with components of the steering column assemblies in a manner that would potentially damage the steering column assemblies. There also is a need to manage inventory being manufactured and inspected to help assure that assemblies that fail to meet certain criteria are segregated from those assemblies that do meet such criteria.

The following U.S. patent documents may be related to the present teachings: Published US. Patent Application Nos. 20020101695 and 20130170734; and U.S. Pat. Nos. 5,162,659; 5,257,361; and 5,426,309, all of which are incorporated by reference herein for all purposes.

### SUMMARY

The present teachings make use of a simple, yet elegant, approach to non-contact inspection of a steering column assembly by which the steering column assembly is rotatably supported at least partially along its length, and is rotated about a longitudinal axis so that data (e.g., profile data) can be gathered about a feature of interest by an optical detection device and used to assure the presence of the feature of interest and/or to determine if the feature of interest meets certain predefined criteria. As will be gleaned from the following, the teachings contemplate an apparatus (and associated method) for inspecting a steering column assembly including at least one motorized roller support assembly that is adapted to rotatably support a steering column assembly at least partially along its fully telescopically extended length (e.g., it is adapted to support at least about 2 percent, 5 percent, 10 percent, 20 percent of the length or longer of the steering column assembly, or possibly less than about 50 percent, 35 percent or 25 percent). The at least one optical scanning device (which desirably is spaced apart from the steering column assembly under inspection) is adapted to optically scan a feature of interest of the steering column assembly (for example, by emitting a light beam such as a laser beam (e.g., a blue laser beam), which may be diffuse, onto the steering column assembly at one or more locations at which the feature of interest is supposed to be and detecting reflections from the steering column assembly (e.g., using a solid state detector, such as a complementary metal oxide semiconductor (CMOS) detector))), while the shaft of the steering column assembly is rotated for gathering data for identifying one or more deviations from one or more predetermined values for the feature of interest.

In one aspect, the present teachings pertain generally to an apparatus for inspecting a steering column assembly having a length, a first end, a second end, and a longitudinal axis. The apparatus includes at least one support structure having a longitudinal axis. The apparatus also has at least one motorized roller support assembly that includes a work-piece drive motor, and one or more rollers adapted to be driven by the work-piece drive motor. The at least one motorized roller support assembly may be carried on the at least one support structure. The at least one motorized rover support assembly is adapted for supporting the steering column assembly over a portion of its length at a location between the first end and the second end of the steering column assembly, and for rotating the steering column assembly. The apparatus also includes at least one optical scanning device adapted to optically scan a feature of interest of the steering column assembly while the steering column assembly is rotated for gathering data for identifying one or more deviations from one or more predetermined values for the feature of interest. For instance, the at least one optical scanning device may emit a light beam and the at least one optical scanning device may be oriented so that the beam is aimed at the feature of interest of the steering column assembly and reflected tight of the beam off the feature of interest can be detected by the at least one optical scanning device (e.g., using a sold state or other detector that can issue a signal based upon the reflected light that it receives). Upon receiving the steering column assembly at a location between its first end and its second end, the at least one work-piece drive motor operates to rotate the one or more rollers to thereby rotate the steering column assembly about its longitudinal axis so that is can be scanned by the at least one optical scanning device,

Other features may form a part of the apparatus, as will be apparent from the teachings herein. For example, the at least one optical scanning device and the at least one motorized roller assembly may be both carried on a common support structure. The apparatus may include at least one marking device adapted for marking a visual indicator onto a surface of the steering column assembly based upon the results of the inspection; the at least one marking device may include a fluid nozzle adapted for spraying the visual indicator onto a predetermined location of the steering wheel assembly. The at least one marking device may also be carried on a common support structure with the at least one motorized roller support assembly, and/or the at least one optical scanning device, The at least one motorized roller support assembly may include a motor that drives at least two opposing rollers (which may be spaced apart from each other, e.g., by about 1 to about 15 mm, or even about 2 to about 10 mm) and may be adapted to roil a generally cylindrical portion of the steering column assembly while also supporting the steering column assembly over at least a portion of its length.

The apparatus may include an idler roller assembly (e.g., one that is axially aligned with a longitudinal axis of the at least one motorized roller support assembly and thus generally parallel with an axis of rotation of the steering column assembly) that is adapted to receive at least a portion of the steering column subassembly for rolling the steering column assembly in response to the rotation of the motorized roller support assembly. The apparatus may include at least one controller adapted to be programmed with data about a desired surface profile for a feature of interest of the steering wheel subassembly, and is adapted to compare a detected value obtained from the at least one three-dimensional scanner and based upon the comparison is adapted to issue a signal, which may in turn trigger a visual and/or audible alarm, and/or issue a signal for causing at least one marking device to apply a marking upon the steering column assembly.

As will be seen further herein, the apparatus is such that the at least one motorized support assembly and any idler roller assembly are adapted to support the steering column assembly solely from a location at or below the longitudinal axis of the steering column assembly. In this regard, the at least one motorized support assembly and any roller assembly may be the sole means of supporting the steering column assembly on the apparatus. Moreover, the at least one motorized support assembly and any idler roller assembly may be configured to support the steering column assembly so that one or both of the first and second ends of the steering column assembly are free of contact with any support structure.

In another aspect, the present teachings also contemplate a method of non-contact inspection of a steering column assembly. The method may employ using an apparatus in accordance with the present teaching. For instance, the method may include a step of supporting a steering column assembly from a location beneath the longitudinal axis of the steering column assembly. The method may include a step of rotating the steering column assembly about its longitudinal axis while scanning the steering column assembly with at least one optical scanning device for one or more features of interest for the steering column assembly. A step may be employed of comparing data obtained about the one or more scanned features of interest with a predetermined value for the one or more scanned features of interest. Based upon the comparing step, there may also be a step of identifying whether or not the steering column assembly conforms with the predetermined value.

A method in accordance with the present teachings may include steps of providing a steering column assembly that includes an upper shaft subassembly and a lower shaft subassembly that are joined together with at least one stake, wherein the stake optionally may be elongated and oriented generally transverse relative to a longitudinal axis of the steering column assembly; rotating the steering column assembly about its longitudinal axis while scanning with the at least one optical scanning device for ascertaining data about the at least one stake; comparing data obtained about the at least one stake with a predetermined value for the at least one stake; and based upon the comparing step, identifying whether or not the steering column assembly conforms with the predetermined value.

There may be a step employed of applying a marking to the steering column assembly based upon the results of the comparing step. A step may be employed of detecting whether a marking has been applied to the steering column assembly and based upon such detecting step interrupting a further assembly operation. A step may be employed of scanning a reference steering column assembly for obtaining qualitative information about relative positions of at least one feature of interest, without regard to dimensions of any of such features, for use thereafter in the comparing step. A method in accordance with the present teachings may include repeating the steps for a plurality of steering column assemblies each being designed to have the same features, and based upon the identifying step, segregating one or more steering column assemblies that conform with the predetermined value from one or more steering column assemblies that do not conform with the predetermined value.

The present teachings provide a number of technical benefits, including but not limited to the ability to consistently and reproducibly inspect steering column assemblies for assuring that the assemblies meet predefined criteria, the ability to minimize operations for assuring that a steering column under inspection is properly supported, the ability to inspect steering column assemblies before installation into a vehicle (e.g., a location of manufacture or storage), the ability to identify nonconforming steering column assemblies before additional costly assembly steps are performed and to thereby help reduce scrap rates of expensive assemblies, or any combination of the foregoing.

### BRIEF DESCRIPTION OF THE DRAWINGS

FIG. 1A is a side sectional view of an illustrative steering column assembly that may be inspected in accordance with the present teachings.

FIG. 1B is an enlarged view of an intended design of an illustrative stake that may be the subject of inspection in accordance with the present teachings.

FIG. 2A is a perspective view of an illustrative apparatus in accordance with the present teachings.

FIG. 2B is a side sectional view of the apparatus of FIG. 2A with a steering column assembly loaded thereon for illustration.

FIG. 2C is a perspective transparent view of a motorized roller support assembly for the apparatus of FIG. 2A.

FIG. 3 is a schematic of an illustrative assembly that includes the apparatus of the present teachings.

### DETAILED DESCRIPTION

As required, detailed embodiments of the present teachings are disclosed herein; however, it is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

In general, and as will be appreciated from the description that follows, the present teachings pertain to pre-vehicle installation quality inspection of steering column assemblies to assure that the assemblies being inspected have the intended design features and meet the intended design criteria. The steering column assemblies generally are envisioned to have an intended design such that the assemblies have a telescoping shaft assembly. The present teachings thus pertain generally to an apparatus and method for inspecting a steering column assembly (e.g., an inner shaft assembly) having a longitudinal axis, a first end, a first end portion extending from the first end along the longitudinal axis from the first end, a second end, a second end portion extending from the second end toward the first end along the longitudinal axis. One object of the teachings thus is to help assure that a steering column assembly being inspected has the intended design features, such as the features described above generally, and more particularly addressed herein, and/or that the intended design features are acceptably positioned, are of an acceptable geometry, have an acceptable surface appearance, and/or have acceptable dimensions.

More particularly, the present teachings pertain generally to an apparatus and method for inspecting an inner steering column shaft assembly that is employed to form a telescopic steering column assembly having a longitudinal axis. In particular, one or more stakes for joining components of the steering column assembly (e.g., adjoining longitudinally extending components of the inner steering column shaft assembly) are inspected. The inner steering column shaft assembly has a first end, a first end portion, a second end, and a second end portion. The first end portion is defined by an upper shaft subassembly, and the second end portion is defined by a lower shaft subassembly. The upper shaft subassembly is telescopically connected with the lower shaft subassembly. For instance, the upper shaft subassembly may be telescopically assembled to the lower shaft subassembly by a spline shaft associated with the upper or lower shaft subassembly and a matingly coupled tube spline associated with the other of the upper or lower shaft subassembly. The upper shaft subassembly may include a steering wheel interface shaft that extends to and includes the first end of the steering column assembly. It may be rotatably supported by one or more bearings contained within an outer column tube in a resulting assembly. The lower shaft subassembly may include an intermediate shaft interface shaft extending toward and including the second end of the assembly, which is adapted for coupling with an intermediate shaft, the latter of which, in turn, may couple with a rack and pinion assembly. The intermediate shaft interface shaft may be rotatably supported (e.g., by one or more suitable bearings) within the column tube (e.g., at a location proximate a forward end of the column tube). The intermediate shaft interface shaft may be coupled with one of the spline shaft or the spline tube by way of a suitable stake.

As indicated, in the manufacture of this assembly, one or more stakes may be formed to mechanically secure two or more components together. The stakes typically include a zone of plastic deformation of an outer structure (e.g., a tube) for bringing it into a fixed engaging contact with an inner structure (e.g., a shaft). Though any suitable geometry for a stake may be employed, in one illustrative aspect, the geometry is generally elongated, and may be generally rectangular. The stake may have a width (Wₛ) and a length (Lₛ). The length may be oriented in a direction that is generally transverse to the longitudinal axis of the steering column assembly. It may also be oriented diagonally or parallel relative to the longitudinal axis of the steering column assembly. The stake may have a width that ranges from about 1 to about 10 mm (e.g., about 2 to about 7 mm). The stake may have a length that ranges from about 5 to about 25 mm (e.g., about 8 to about 20 mm).

In the illustrative embodiment for the present teachings there is at least one stake, and there may be two stakes (e.g., only two stakes). A stake may be located for directly joining the steering wheel interface shaft with one of the spline shaft or the spline tube. A stake may be located for joining the intermediate shaft interface shaft with the other of the mating spline shaft or spline tube.

In one general aspect of the teachings, there is thus envisioned the inspection of one or more stakes for joining a tube in tube structure, and/or a shaft in tube structure. The teachings may also be suitably employed for inspection of one or more crimps and/or dimples, and/or other plastic deformity for joining a tube in tube, and/or a shaft in tube structure.

With respect to the apparatus of the present teachings, in one aspect, the present teachings pertain generally to an apparatus that includes at least one support structure having a longitudinal axis. The apparatus desirably has a first end and a second end and a longitudinal axis. The apparatus also has at least one motorized roller support assembly that includes a work-piece drive motor, and one or more rollers adapted to be driven by the work-piece drive motor. An example of a suitable motor is a servo motor, such as one having the characteristics of a motor available commercially from Omron (e.g., under the number R88M-K0030LS2). The at least one motorized roller support assembly may be carried on the at least one support structure (e.g., on an upper surface of a generally planar support structure). The at least one motorized roller support assembly is adapted for supporting the steering column assembly over a portion of its length (e.g., over only a portion of its length, such as over less than half of its fully telescopically extended length) at a location between its first end and its second end, and for rotating the steering column assembly. The rollers of the motorized roller support assembly (which may be in spaced opposing relation to each other) may thus be located at an intermediate location along the length of the steering column assembly that is inspected thereon. For instance, if the steering column assembly is divided into equal thirds when placed on the apparatus, the rollers may be located in a region generally corresponding with the middle third of the steering column assembly, though other locations are also possible.

The at least one motorized roller support assembly may include one or a plurality (e.g., at least one pair) of rollers that are adapted to be driven by the work-piece drive motor (e.g., directly by attachment of an output shaft of the work-piece drive motor to a roller, or via one or more intermediate gears (such as by an idler gear that drives a gear associated with one or more roller)), a roller or the like, which is operatively connected with an output shaft of the work-piece drive motor. Any such gears may rotate about parallel rotational axes and/or generally in a common plane or a parallel plane relative to each other. The at least one motorized roller support assembly is configured so that the steering column assembly can be placed thereon (e.g., from above), and rolled about the longitudinal axis of the steering column assembly. One or more of the rollers have a longitudinal axis that is generally parallel with the longitudinal axis of a steering column assembly placed thereon. Each of the rollers may have a length along its longitudinal axis for contacting the steering column assembly. For example, the rollers may have a length of about 20 to about 100 mm, about 30 to about 80 mm, or even about 40 to about 60 mm (e.g., about 50 mm). Opposing rollers may be the same or different length. The rollers may be in staggered relation to each other, and may thus not necessarily be directly opposite each other over some or all of their length. The total length of the steering column that is in contact with the rollers may be at least about 2 percent, 5 percent, 10 percent, 20 percent or more of the length of the steering column assembly in its fully telescopically extended position. The total length of the steering column that is in contact with the rollers may be below about 50 percent, 40 percent, or 30 percent of the length of the steering column assembly in its fully telescopically extended position. For making such measurements, if two opposing rollers are employed the length of contact with only the longest of the rollers is used. Thus, if two rollers each have a 5 cm length in contact with the steering column assembly, then the length of the steering column assembly in contact with the rollers is only 5 cm, not 10 cm.

The rollers may be generally cylindrical, such that they contact a steering column assembly placed thereon in a generally line contact manner. It is also possible that the rollers may include one or a plurality of rollers adapted to contact the steering column assembly in a generally point contact manner.

The rollers may be supported for rotation in a suitable drive roller housing, which may also house a work-piece drive motor. The housing may project upward from the support structure of the apparatus. The housing may have a longitudinally oriented well. The well may extend from a first end of the housing to the second end of the housing and has a width that is sufficiently large so that the steering column assembly can be placed into the well without contacting the housing and rest in contact with one or more of the rollers.

The apparatus may include at least one idler roller assembly (e.g., one that is axially aligned with a longitudinal axis of the at least one motorized roller support assembly and thus generally parallel with an axis of rotation of the steering column assembly) that is adapted to receive at least a portion of the steering column subassembly for roving the steering column assembly in response to the rotation of the motorized roller support assembly. For example, one or a plurality of idler rollers may be supported for rotation in a suitable idler roller housing, which may be free of any motor. Like the drive roller housing, the idler roller housing may project upward from the support structure of the apparatus. The housing may have a longitudinally oriented well. Such well may extend from a first end of the housing to the second end of the housing. The well may have a width that is sufficiently large so that the steering column assembly can be placed into the well without contacting the housing and rest in contact with one or more of the idler rollers. The idler rollers may have a length for contacting the steering column assembly. For example, the rollers may have a length of about 10 to about 80 mm, about 15 to about 60 mm, or even about 20 to about 40 mm (e.g., about 30 mm).

The apparatus may include one or more end plates for helping to locate a steering column assembly in the apparatus and/or for helping to restrict longitudinal translation of the steering column assembly during inspection. Any such end plate may have a height that is at least as high as the location of the longitudinal axis of the steering column assembly placed on the apparatus. By way of example, there may be an end plate located on the first end of the apparatus.

The apparatus of the present teachings optionally may also include at least one suitable marking device adapted for marking a visual indicator onto a surface of a steering column assembly that has been inspected based upon the results of the inspection. For example, if a steering column assembly fails an inspection a marking device may be actuated to mark the steering column assembly. Alternatively, if a steering column assembly passes an inspection a marking device may be actuated to mark the steering column assembly. The at least one marking device may include a coating spray device that includes a spray nozzle that is in quid communication with a source of a liquid coating (e.g., a dye, a colorant, or some other coating) aimed toward a steering column assembly while the steering column assembly is positioned on the apparatus of the present teachings. For example, a suitable bracket may be mounted to the support structure carrying the spray nozzle in opposing relation to a shaft of a steering column assembly being inspected, such that the spray nozzle is adapted to spray the shaft with a liquid coating at least partially along a length of the opposing shaft. The spray nozzle may also be adapted to spray an end of the steering column assembly. By way of example, at least one marking device may be located proximate the second end of the apparatus. The at least one marking device may also be carried on a common support structure with the at least one motorized roller support assembly.

The apparatus also includes at least one optical scanning device (which may also be carried in the common support structure with the at least one marking device and the at least one motorized roller support assembly), which may be adapted to optically scan a feature of interest of the steering column assembly while the steering column assembly is rotated for gathering data for identifying one or more deviations from one or more predetermined values for the feature of interest. For instance, the at least one optical scanning device may emit a light beam and the at least one optical scanning device may be oriented so that the beam is aimed at the feature of interest of the steering column assembly and reflected light of the beam off the feature of interest can be detected by the at least at least one optical scanning device. Upon receiving the steering column assembly at a location between its first end and its second end, the at least one work-piece drive motor operates to rotate the one or more rollers to thereby rotate the steering column assembly about its longitudinal axis so that is can be scanned by the at least one optical scanning device.

In accordance with the illustrative embodiment herein, there may be one or more optical scanning devices that are positioned to generally oppose the location of each stake in a steering column assembly. For example, if there are two stakes, there may be two optical scanning devices that are located opposite the intended and expected location of any stake for a steering column assembly placed on the apparatus for inspection. Any such optical scanning device may be positioned at a location below the steering column assembly. Any such optical scanning device may be spaced apart from the steering column assembly. For example, it may be spaced at a distance of about 1 centimeters (cm) to about 20 centimeters (e.g., about 3 cm to about 15 cm).

The at least one optical scanning device may be a suitable in-line profile measurement device. The at least one optical scanning device may include a light beam emitter (e.g. a laser beam emitter), which may be adapted to emit a generally diffuse beam (e.g., the beam may be emitted so that, at the location where it reflects off a steering column assembly, a linear segment (e.g., a blue linear segment) is visible). For example, it may include a blue laser beam emitter (i.e., it emits blue light at a wavelength of about 360 to about 480 nm (e.g., at about 405 nm)). The at least one optical scanning device may include a suitable detector positioned relative to the light beam emitter for detecting reflection from a surface of the steering column assembly being inspected. The detector may include a solid state detector, such as a complementary metal oxide semiconductor detector. The at least one optical scanning device may include one or more lenses (e.g., at least one cylindrical lens) for focusing the beam from the emitter source, and/or a two dimensional lens device (e.g., a lens device that may include one or a plurality of lenses that can concentrate light entering it from various angles to a single point, such as an Ernostar lens) for receiving at least a portion of the light that is reflected from the steering column subassembly. The at least one optical scanning device may include a suitable processor adapted to acquire data from the detector and output such data to a suitable display device. The processor (or another processor) may be suitably programmed to perform a comparison of data acquired from inspecting a steering column assembly with predetermined values (e.g., values stored in memory associated with the processor performing the comparison) or other data about a known reference steering column assembly. The processor may be suitably programmed to output the results of an inspection of a steering column assembly, in this regard, the processor may be suitably programmed to cause an audible alarm, a visual alarm or both to issue if a steering column assembly passes or fails an inspection. The processor may be suitably programmed to identify one or more features of interest that fails to meet a predetermined criteria for such feature. An example of a suitable optical scanning device has the characteristics of a commercially available optical scanning device such as Model No. LJ-V7080, available from Keyence Corporation of America.

The apparatus may include at least one controller adapted to control operation of the work-piece drive motor, the at least one optical scanning device, or both. For example, the controller may be programmed to cause the work-piece drive motor to rotate while the at least one optical scanning device performs a scan and obtains data.

As will be seen further herein, the apparatus is such that the at least one motorized support assembly and any idler roller assembly are adapted to support the steering column assembly solely from a location at or below the longitudinal axis of the steering column assembly. In this regard, the at least one motorized support assembly and any roller assembly may be the sole means of supporting the steering column assembly on the apparatus. Moreover, the at least one motorized support assembly and any idler roller assembly may be configured to support the steering column assembly so that the first and second ends of the steering column assembly are free of contact with any support structure.

The apparatus may also be part of an assembly that includes a housing. The housing may be a substantially enclosed housing. The apparatus, the housing, or both, may have an associated display device for providing an operator with visual results from an inspection. There may be one or more suitable input devices for allowing an operator to control operation of the machine. There may be one or more bins for collection of steering assemblies that pass or fail inspection. There may be one or more load cells associated with the collection bins apparatus that is in electronic signaling communication with a processor that identifies if a steering column assembly passes or fails an inspection. In this manner the load cell can assure that a steering column assembly that passes or fails an inspection is placed in the proper collection bin. There may be other suitable hardware to assure that an operator has properly segregated inspected steering column assemblies to separate the failed from the passed assemblies. The apparatus may include a device (e.g., an optical detector) that optically analyzes whether a coating has been applied to a steering column assembly. There may be a rack that supports a steering column assembly before and/or after inspection. There may be one or more additional assembly stations within or outside of the housing.

The apparatus may be part of an assembly that includes one or any combination of an optional housing, an output display, a collection bin, a load cell for detecting the presence of an assembly in the collection bin, a suitable processor for controlling one or more operations of the apparatus, a user interface far inputting operation commands, or an optical detector for detecting the presence or absence of a coating from the spray device. There may be a rack that supports a steering column assembly before and/or after inspection. There may be one or more additional assembly stations within or outside of the housing.

As can be appreciated from the above, use of the apparatus of the present teachings may include the general steps of supportingly locating a steering column assembly on the apparatus. The steering column assembly may be placed on the apparatus from above the apparatus. The apparatus may be free of any structure that prevents upward movement of the steering column assembly while it is positioned on the apparatus. The apparatus may support the steering column assembly so that one or both of the first and second ends of the steering column assembly is freely suspended or otherwise not in contact with any structure. The steering column assembly may be placed on the apparatus so that it only contacts the apparatus at the at least one motorized roller support assembly and at any idler roller assembly. Upon contacting the at least one motorized roller support assembly, there may be a step of rotating the steering column assembly about its longitudinal axis, such as by rotatably driving one or more rollers about their longitudinal axis so that the rollers engage an outer surface of the steering column assembly and cause the steering column assembly to rotate about its longitudinal axis. During the rotating step, data may be obtained continuously about the periphery of a region of interest, data may be obtained intermittently about the periphery of the region of interest, or both. For example, a plurality of scans may be made (e.g., 5 or more, 10 or more, 20 or more, 30 or more, 40 or more, 360 or less, 180 or less, 90 or less, or otherwise) at predetermined intervals for each revolution of the steering column assembly about its longitudinal axis. One or a plurality of revolutions may be made about the longitudinal axis for performing an inspection.

While the steering column assembly is rotated about its longitudinal axis, a surface feature of interest is optically analyzed. For example, a step of optically scanning a feature of interest (e.g., a surface feature of interest) may be performed. The optical scanning may be to analyze for the presence or absence of a feature of interest, and/or for one or more characteristics of a feature of interest selected from a stake location, a stake orientation, the relative position of a stake as compared with another feature, a stake geometry, a stake depth, a stake length, a stake width, some other dimension of a stake, or any combination of the foregoing.

A step may be performed of comparing data obtained from the scanning with a known reference value. For example, a step may be performed of scanning a steering column assembly that satisfies predetermined desired quality criteria. Data obtained from such scanning may be stored and used in the comparing step. One approach to the comparing step involves comparing relative positions of a feature of interest with predetermined values for relative positions, without regard to measurements of dimensions.

Predetermined reference data may be obtained by scanning a part having features of interest known to satisfy predetermined quality criteria. Such data may be stored in memory and recalled for use when performing a comparing step. It is possible that the reference data will include: relative positions of two or more surface features, one or more dimensions associated with one or more features, a surface topography for one or more features, or any combination thereof. In one approach it is envisioned that the comparing step compares only relative positions of two or more features as between those of a known reference part and those of an assembly being inspected. That is, a qualitative comparison is made of the surface features without regard to any quantitative data about the feature. There may be a step of applying an optically detectable coating (e.g., a paint, a dye, or otherwise) to a steering column assembly to denote whether or not the assembly has passed an inspection. There may be a step of assembling a further component onto the steering column assembly based upon the results of inspection. For example, an outer tube may be assembled onto the steering column assembly after the inner steering column assembly has been inspected to assure that it meets predetermined criteria, such as for assuring satisfactory stakes have been made.

There may be one or more steps of applying a coating onto a steering column assembly that passes or fails an inspection. The method may include a step of issuing an alarm signal (e.g., an audible and/or visual signal) if a steering column assembly being inspected fails to meet certain criteria, or alternatively, issuing an alarm signal (e.g., an audible and/or visual signal) if a steering column meets certain criteria. For example, there may be a step of optically analyzing (e.g., using an automated optical scanning device) if an optically detectable coating has been applied, and thereafter issuing an alarm signal based upon the result of the step of optically analyzing.

Based upon the presence or absence of an alarm signal, an operator may place a steering column assembly into a collection bin. For example, there may be a collection bin for a steering column assembly that passes an inspection, a collection bin for a steering column assembly that fails an inspection, or both. Based upon the results of the inspecting, there may be one or more steps of segregating steering column assemblies that pass inspection from those that fail inspection. The segregating may include locating one or more steering column assemblies into an appropriate collection bin,. There may be a step of sensing (e.g., using a load sensor, a motion sensor, or otherwise) whether an operator has placed a steering column assembly into a collection bin as directed.

One or more other steps may be employed, such as for controlling operation of the apparatus of the present teachings. For example, there may be one or more security steps employed to assure only authorized operators use the apparatus. For example, there may be a step of detecting data about an operator's fingerprint and comparing it against data about fingerprints of authorized operators stored in memory.

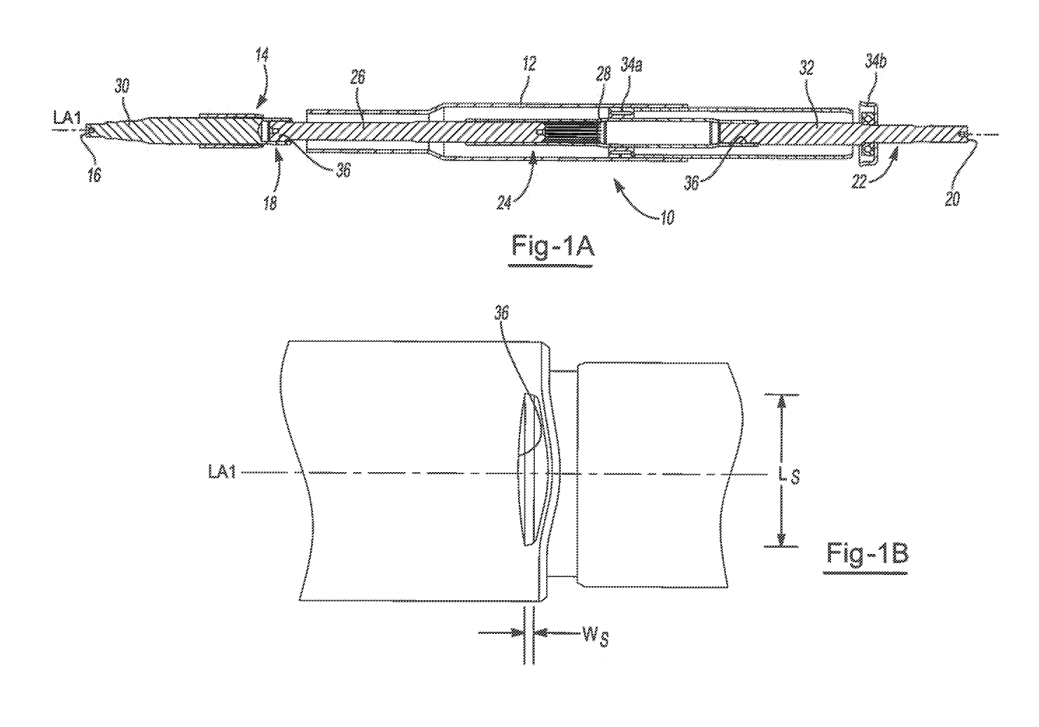

Referring now to FIGS. 1A and 1B, there is illustrated an intended design of an illustrative steering column assembly 10 that may be inspected in accordance with the present teaching. The steering column assembly has a longitudinal axis (LA1) and has an outer tube 12 that partially surrounds and encloses an inner steering column shaft assembly 14. The inner steering column shaft assembly 14 has a first end 16, a first end portion defined by an upper shaft subassembly 18, a second end 20, and a second end portion defined by a lower shaft subassembly 22. The upper shaft subassembly 18 is telescopically connected with the lower shaft subassembly 22 over a connection region 24, namely a length of the assembly where the two subassemblies matingly engage each other. For instance, the upper shaft subassembly 18 may be telescopically assembled to the lower shaft subassembly 22 with mating slidable tubes, such as by a spline shaft 26 (having a plurality of longitudinally extending splines on its outer surface) associated with the upper shaft subassembly 18 and a matingly coupled spline tube 28 (having a plurality of longitudinally extending splines on its inner wall) associated with the lower shaft subassembly 22. The upper shaft subassembly 18 may include a steering wheel interface shaft 30 that extends to and includes the first end 16 of the steering column assembly 10. The lower shaft subassembly 22 may include an intermediate shaft interface shaft 32 extending toward and including the second end of the assembly, which is adapted for coupling with an intermediate shaft (not shown), the latter of which in turn may couple with a rack and pinion assembly. The intermediate shaft interface shaft 32 may be rotatably supported (e.g., by one or more suitable bearings 34a and 34b) within the column tube (e.g., at a location proximate a forward end of the column tube). The intermediate shaft interface shaft 32 may be coupled with the spline tube 28 by way of a suitable stake 36. The steering wheel interface shaft 30 may be coupled with the spline shaft 26 with another stake 38.

With reference to FIG. 1B, in the manufacture of this assembly, stakes are formed by plastically deforming one component relative to another so that two components are frictionally and/or otherwise mechanically joined so as to mechanically secure two or more components together. In the illustrated embodiment, the geometry of the stake 36 is generally elongated, and may be generally rectangular. The stake may have a width (Wₛ) and a length (Lₛ). The length may be oriented in a direction that is generally transverse to the longitudinal axis of the steering column assembly. The stake, for example, can have a width of about 2 mm and a length of about 12 mm.

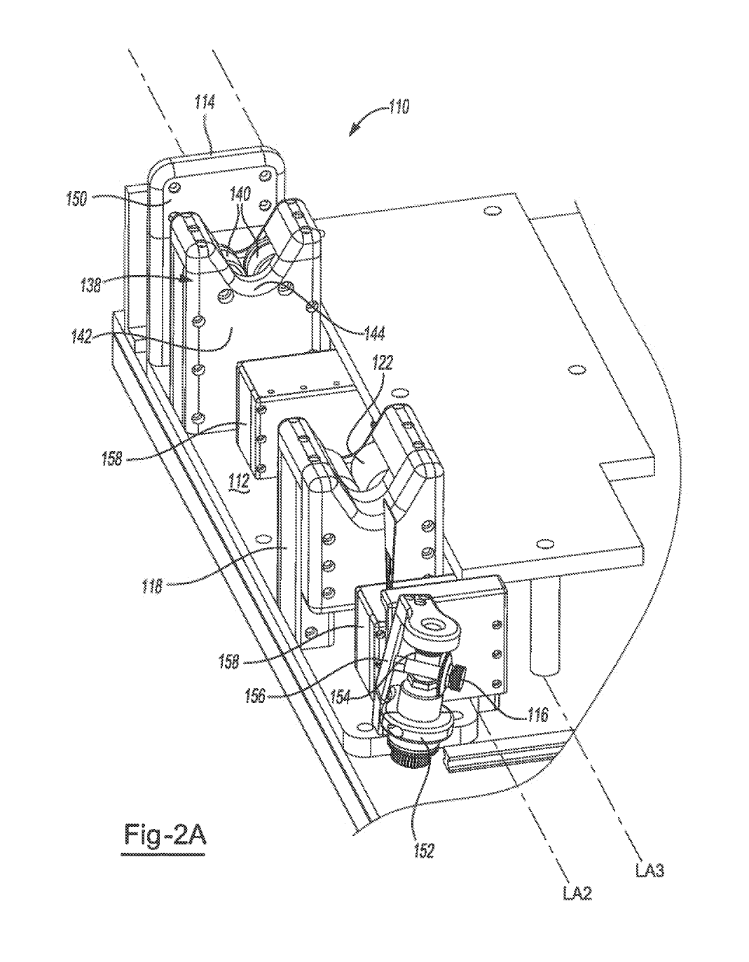

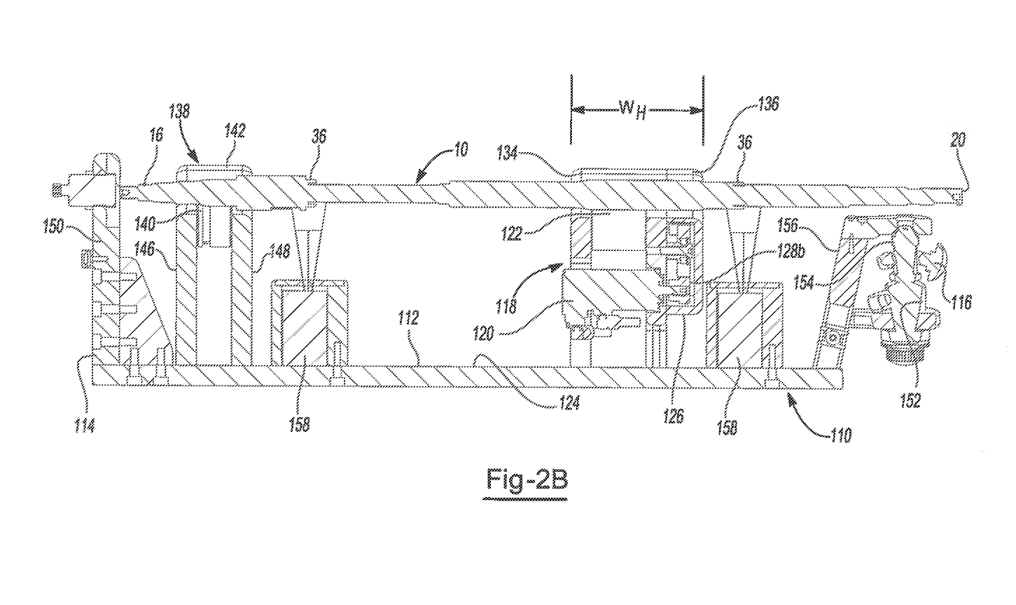

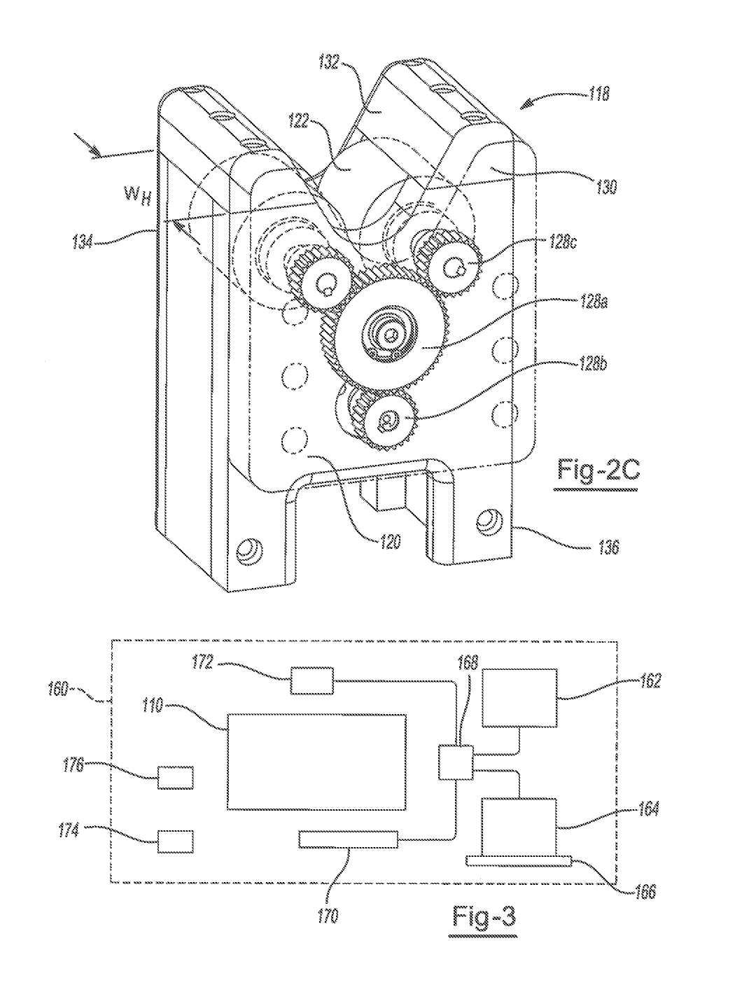

With reference to FIGS. 2A-2C, there is seen how an illustrative steering column assembly, such as the assembly 10 (of FIG. 1A), is inspected using an apparatus 110 of the present teachings.

The apparatus 110 includes at least one support structure 112 having a Longitudinal axis (LA2). The apparatus desirably has a first end 114 and a second end 116 and a longitudinal axis (LA3) which is shown as being generally parallel with the longitudinal axis of the support structure 112 and the longitudinal axis of a steering column assembly that is inspected thereon. The apparatus also has a motorized roller support assembly 118 that includes a work-piece drive motor 120, and a pair of opposing miters 122 adapted to be driven by an output shaft of the work-piece drive motor 120, and which are spaced apart (e.g., by about 3 mm). The motorized roller support assembly 118 may be carried on an upper surface 124 of the support structure 112. As seen, the motorized roller support assembly 118 is adapted for supporting the steering column assembly over a portion of its length at a location between its first end 114 and its second end 116, and for rotating the steering column assembly.

The rollers 122 of the motorized roller support assembly 118 are elongated, cylindrical and have a length of between about 2 and about 20 percent (e.g., about 4 to about 8 percent) of the length of the steering column assembly in its fully telescopically extended position. The rollers may have a length of about 20 to about 100 mm, about 30 to about 80 mm, or even about 40 to about 60 mm (e.g., about 50 mm). The rollers may be located at an intermediate location along the length of the steering column assembly that is inspected thereon. For instance, if the steering column assembly is divided into equal thirds when placed on the apparatus, the rollers are located in a region generally corresponding with the middle third of the steering column assembly. As seen in FIGS. 2B and 2C, at least one of the rollers is drivingly coupled to an output shaft 126 of the work-piece drive motor 120, such as by an intermediate rotating member, and specifically an idler gear 128a that is driven by an output shaft gear 128b and which in turn drives a roller gear 128c (e.g., a gear mounted on a common shaft with the roller and about which a suitable roller bearing may be positioned), the latter components being contained within a drive roller housing 130, which may include a tunnel as depicted in FIG. 2C. As also seen in FIG. 2C, the gears may rotate about parallel rotational axes and generally in a common plane. An example of a suitable motor is a servo motor, such as one having the characteristics of a motor available commercially from Omron (e.g., under the number R88M-K0030LS2). For the embodiment illustrated, the total length of the steering column assembly that is in contact with rollers when a steering column assembly is placed thereon is below about 20 percent of the length of the steering column assembly in its fully telescopically extended position. For example it may be about 10 percent of the length of the steering column assembly in its fully telescopically extended position.

The drive roller housing 130 projects upwardly from the support structure 112 of the apparatus 110. The housing 130 has a longitudinally oriented well 132 that extends from a first end 134 of the housing to the second end 136 of the housing and has width (W_{H}) that is sufficiently large so that the steering column assembly can be placed into the well and rest in contact with one or more of the rollers.

The apparatus 110 includes an idler roller assembly 138 that is axially aligned with a longitudinal axis of the motorized roller support assembly 118 and thus generally parallel with an axis of rotation of the steering column assembly when placed thereon. The idler roller assembly 138 is adapted to receive at least a portion of the steering column subassembly for rolling the steering column assembly in response to the rotation of the motorized roller support assembly 118. For example, a plurality of generally cylindrical idler rollers 140 are supported for rotation in an idler roller housing 142, which is free of any motor. Like the drive roller housing 130, the idler roller housing 142 projects upwardly from the support structure 112 of the apparatus 110. The idler roller housing 142 also has longitudinally oriented well 144 that extends from a first end 146 of the idler roller housing to a second end 148 of the idler roller housing 142.

The apparatus 110 is shown as having an upwardly projecting end plate 150 for helping to locate a steering column assembly in the apparatus and/or for helping to restrict longitudinal translation of the steering column assembly during inspection.

The apparatus 110 also includes an upwardly aimed marking device 152 adapted for marking a visual indicator onto a surface of a steering column assembly that has been inspected based upon the results of the inspection. The marking device 152 has a spray nozzle 154 that is in fluid communication with a source of a liquid coating (e.g., a dye, a colorant, or some other coating) and is aimed toward a steering column assembly while the steering column assembly is positioned on the apparatus of the present teachings. For example, a bracket 156 supports the spray nozzle 154 in opposing relation to a shaft of a steering column assembly being inspected, such that the spray nozzle is adapted to spray the shaft with a liquid coating at least partially along a length of the opposing shaft.

The apparatus 110 also includes a pair of optical scanning devices 158 adapted to optically scan a feature of interest (e.g., a pair of longitudinally spaced stakes) of the steering column assembly while the steering column assembly is rotated for gathering data for identifying one or more deviations from one or more predetermined values for the feature of interest. An example of a commercially available optical scanning device is Model No. LJ-V7080, available from Keyence Corporation of America.

With reference to FIG. 3, the apparatus 110 may be part of an assembly that includes one or any combination of an optional housing 180, an output display 162, a collection bin 164, a load cell 166 for detecting the presence of an assembly in the collection bin 164, a suitable processor 168 for controlling one or more operations of the apparatus, a user interface 170 for inputting operation commands, or an optical detector for detecting the presence or absence of a coating from the marking device 152. There may be a rack 174 that supports a steering column assembly before and/or after inspection. There may be one or more additional assembly stations 176 within or outside of the housing 160.

As can be appreciated from the above, use of the illustrated apparatus 110 of the present teachings may include the general steps of supportingly locating a steering column assembly 10 as depicted in FIG. 1A on the apparatus 110 so that at least the second end 20 of the steering column assembly 10 is suspended and free of contact with the apparatus. In this regard, a step may be performed of supporting locating a steering column assembly over only a portion of its length. There may be a step of locating the steering column assembly so that its first end 16 may abut the end plate 150.

A step may be performed of actuating the work-piece drive motor 120 to cause miters 122 to rotate and thereby cause the steering column assembly placed thereon to rotate, while the optical scanning devices 158 scan the steering column assembly (e.g., for obtaining data about the presence or absence of a stake 36, a stake location, a stake orientation, the relative position of a stake as compared with another feature, a stake geometry, a stake depth, a stake length, a stake width, some other dimension of a stake, or any combination of the foregoing).

A step may be performed of comparing data obtained from the scanning with a known reference value. For example, a step may be performed of scanning a steering column assembly that satisfies predetermined desired quality criteria (e.g., for a stake). Data obtained from such scanning may be stored and used in the comparing step. One approach to the comparing step involves comparing relative positions of surface features of interest with predetermined values for relative positions, without regard to measurements of dimensions. Based upon the results of the inspecting, there may be one or more steps of segregating steering column assemblies that pass inspection from those that fail inspection. The segregating may include locating one or more steering column assemblies in a collection bin. There may be one or more steps of applying a coating onto a steering column assembly that passes or fails an inspection. For example, the spray nozzle 154 may dispense a coating of a dye or other detectable coating onto the steering column assembly. There may be one or more steps of analyzing (e.g., optically, such as with an optical detector, or manually) whether a steering column assembly has a coating applied thereto prior to installation of the steering column assembly in a vehicle.

For instance, a step of scanning the steering column assembly may be performed using optical detection or scanning devices 158. Based upon the scanning step, a step of indicating whether the coating is applied may be employed. The readout device (output display) 162 may display a result and/or display an instruction to the operator. By way of illustration, without limitation, the readout display may issue a read-out that instructs an operator to load a faulty steering column assembly into the collection bin 164. A step of sensing whether the steering column assembly has been loaded in the bin may be performed, such as by the load cell 165. If the steering wheel assembly has not been loaded, the apparatus may temporarily cease operation until such loading has occurred. There may also be a step of assuring that steering column assemblies loaded into the bin are not removed except by predetermined operators, such as an operator that has entered a suitable security code, or has satisfied some other security criteria. A step of assembling an outer column tube onto the assembly may be performed if the inspection shows that the steering column assembly satisfied the desired criteria for an acceptable assembly (e.g., by showing that the stakes were properly made). Thus, the teachings herein also envision use of the inspection apparatus and method for the assembly of a steering column assembly, preferably before it is installed in a vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

As can be appreciated, variations in the above teachings may be employed. For example, it may be possible to employ one or more motors for rotating the steering column assembly at or near its second end and/or at some intermediate location.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic end novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

What is claimed is:

1) An apparatus for performing an inspection of a steering column assembly having a length, a first end, a second end and, longitudinal axis, comprising:
a. at least one support structure having a longitudinal axis;
b. at least one motorized roller support assembly that is carried on the at least one support structure and that includes at least one work-piece drive motor, and one or more rollers adapted to be driven by the at least one work-piece drive motor, the at least one motorized roller support assembly being adapted for supporting the steering column assembly over at least a portion of its length at a location between its first end, and its second end, and for rotating the steering column assembly about its longitudinal axis;
c. at least one optical scanning device adapted, to optically scan a feature of interest of the steering column assembly while the steering column assembly is rotated for gathering data for identifying one or more deviations from one or more predetermined values for the feature of interest; wherein the at least one optical scanning device emits a light beam and the at least one optical scanning device is oriented so that the light beam is aimed at the feature of interest of the steering column assembly and reflected light of the light beam off the feature of interest can be detected by the at least at least one optical scanning device; wherein, upon receiving the steering column assembly at a location between its first end and its second end, the at least one work-piece drive motor operates to rotate the one or more rollers to thereby rotate the steering column assembly about its longitudinal axis so that is can be scanned by the at least one optical scanning device.

2) The apparatus of claim 1, wherein the at least one optical scanning, device and the at least one motorized roller support assembly are each carried on a common support structure.

3) The apparatus of claim 1, wherein the apparatus includes at least one marking device adapted for marking a visual indicator onto a surface of the steering column assembly, based upon results of the inspection, and wherein the at least one marking device includes a fluid nozzle adapted for spraying the visual indicator onto a predetermined location of the steering column assembly.

4) The apparatus of claim 3, wherein the at least one optical scanning device, the at least, one motorized roller support assembly and any marking device are carried on a common support structure.

5) The apparatus of claim 1, wherein the at least one motorized roller support assembly includes a motor that drives at least two spaced apart opposing rollers and is adapted to roll a generally cylindrical portion of the steering column assembly while also supporting the steering column assembly over at least about 2 percent of its length but less than about 50 percent length.

6) The apparatus of claim 1, wherein the apparatus further includes an idler roller assembly adapted to receive at least a portion of the steering column assembly for rolling the steering column assembly in response to rotation of the at least one motorized roller support assembly.

7) The apparatus of claim 1, wherein the apparatus includes at least one controller adapted to be programmed with data about a desired surface profile for the feature of interest of the steering column assembly, and is adapted to compare a detected value obtained from the at least one optical scanning device and based upon the comparison is adapted to issue a signal causing at least one marking device to apply a marking upon the steering column assembly.

8) The apparatus of claim 6, wherein the at least one motorized roller support assembly and any idler roller assembly are adapted to support the steering column assembly solely from a location at or below the longitudinal axis of the steering column assembly.

9) The apparatus of claim 8, wherein the at least one motorized roller support assembly and any idler roller assembly are a sole means of supporting the steering column assembly on the apparatus.

10) The apparatus of claim 6, wherein the at least one motorized roller support assembly and any idler roller assembly are configured to support the steering column assembly so that the first and second ends of the steering column assembly are free of contact with any support structure while the steering column assembly is optically scanned.

11) A method of using the apparatus of claim 1, wherein the method includes the steps of providing at least one steering column assembly; rotating the steering column assembly about its longitudinal axis while scanning with the at least one optical scanning device for one or more features of interest for the steering column assembly; comparing data obtained about the one or more scanned features of interest with a predetermined value for the one or more scanned features of interest; and based upon the comparing step, identifying whether or not the steering column assembly conforms with the -a predetermined value.

12) The method of claim 11, wherein the steering column assembly includes an upper shaft subassembly and a lower shaft subassembly that are joined together with at least one stake, which optionally may be elongated and oriented generally transverse relative to a longitudinal axis of the steering column assembly; wherein the method includes rotating the steering column assembly about its longitudinal axis while scanning with the at least one optical scanning device for ascertaining data about the at least one stake; comparing data obtained about the at least one stake with a predetermined value for the at least one stake: and based upon the comparing step, identifying whether or not the steering column assembly conforms with the predetermined value.

13) The method of claim 11, where a step is employed of applying a marking to the steering column assembly based upon the results of the comparing step.

14) The method of claim 11, wherein a step is employed of detecting whether a marking has been applied to the steering column assembly and based upon such detecting step interrupting a further assembly operation.

15) The method of claim 11, wherein the method includes a step of scanning a reference steering column assembly for obtaining qualitative information about relative positions of at least one feature of interest, without regard to dimensions of any of such features, for use thereafter in the comparing step.

16) The method of claim 11, wherein the method includes repeating the steps for a plurality of steering column assemblies each being designed to have the same features, and based, upon the identifying step, segregating one or more steering column assemblies that conform with the predetermined value from one or more steering column assemblies that do not conform with the predetermined value.

17) The method of claim 12, where a step is employed of applying a marking to the steering column assembly based upon the results of the comparing step.

18) The method of claim 12, wherein a step is employed of detecting whether a marking has been applied to the steering column assembly and based upon such detecting step interrupting a further assembly operation.

19) The method of claim 12, wherein the method includes a step of scanning a reference steering column assembly for obtaining qualitative information about relative positions of at least one stake, without regard to dimensions of any of such stakes, for use thereafter in the comparing step.

20) The method of claim 11, wherein the method further includes a step of:
applying a marking to the steering column assembly based upon the e of the comparing step;
detecting whether a marking has been, applied to the steering column assembly and based upon such detecting step interrupting a further assembly operation;
scanning a reference steering column assembly for obtaining qualitative information about relative positions of at least one feature of interest, without regard to dimensions of, any of such features, for use thereafter in the comparing, step; and
repeating the steps for a plurality of steering column assemblies each being designed to have the same features, and based upon the identifying step, segregating one or more steering column assemblies that conform with the predetermined value from one or more steering column assemblies that do not conform with the predetermined value.
